(19) United States
(12) Patent Application Publication
(10) Pub. No.: US 2015/0370655 A1
(43) Pub. Date: Dec. 24, 2015

(54) MEMORY MODULE CONTROLLER SUPPORTING EXTENDED WRITES

(71) Applicant: Hewlett-Packard Development Company, L.P., Houston, TX (US)

(72) Inventors: Joseph A. Tucek, Palo Alto, CA (US); Mark David Lillibridge, Palo Alto, CA (US); Wojciech Golab, Palo Alto, CA (US)

(21) Appl. No.: 14/764,609

(22) PCT Filed: Mar. 15, 2013
(86) PCT No.: PCT/US2013/032414

§ 371 Date: Jul. 30, 2015

(51) Int. Cl. G06F 11/14; G06F 3/06

(52) U.S. Cl. CPC G06F 11/1471; G06F 3/0619; G06F 3/064; G06F 3/0673; G06F 2201/82

(57) ABSTRACT

Example methods and apparatus disclose supporting extended writes to a memory. An example method disclosed herein includes storing recovery information associated with a write request in a memory without processor intervention, the recovery information to facilitate redoing or undoing a write requested by the write request in the event that the write is interrupted, the write request received from a processor and comprising a destination address and new data; and if the write is not interrupted, writing the new data to the destination address in the memory without processor intervention

### BACKGROUND

Some computing systems use random access memory (RAM) devices as intermediary storage for relatively fast access to data that is also stored in long-term mass storage devices (e.g., magnetic memories, optical memories, flash memories, etc.). In this manner, computing systems can perform faster data accesses by copying data from the long-term mass storage devices to the intermediary RAM devices, and by accessing the data from the RAM devices.

Solid-state memory devices for long-term storage include non-volatile random access memory (NVRAM) such as phase-change ram (PCRAM), Memristors, and spin-transfer torque random access memory (STT-RAM). NVRAM is a persistent memory system that maintains data stored therein even when power is removed.

### BRIEF DESCRIPTION OF THE DRAWINGS

FIG. 1A is an example command flow diagram representative of memory access commands processed by an example memory module controller implemented in accordance with the teachings of this disclosure.

FIG. 1B is an example processor system having a memory module with the example memory module controller of FIG. 1A.

FIG. 2 illustrates example command formats representative of an example atomic-write command processed by the example memory module controller of FIGS. 1A and 1B.

FIG. 3 illustrates example command formats representative of an example copy-on-write (COW) write command processed by the example memory module controller of FIGS. 1A and 1B.

FIG. 4 is an example memory module controller of FIGS. 1A, 1B, 2, and/or 3.

FIG. 5 is an example flow diagram representative of a process that may be executed to execute an atomic-write command.

FIG. 6 is an example flow diagram representative of a process that may be executed to perform a recovery of a memory.

FIG. 7 is an example flow diagram representative of a process that may be executed to execute a COW-write command.

### DETAILED DESCRIPTION

Example methods, apparatus, and articles of manufacture disclosed herein may be used to implement memory module controllers that handle atomic write commands and/or copy-on-write (COW) commands. These memory module controllers may log recovery information associated with commands for use in handling interruptions. Examples disclosed herein also enable implementing memory module controllers that perform multi-memory access processes to a memory based on single commands from a processor and/or using less processor intervention than required in prior systems. Disclosed examples may be used to implement memory module controllers in memory modules having non-volatile memories (e.g., flash devices, Memristor devices, PCRAM devices, STT-RAM devices, etc.) and/or volatile memories (e.g., dynamic random access memory (DRAM), static random access memory (SRAM), etc.). Disclosed examples are useful in connection with any suitable type of persistent storage including non-volatile memories and/or volatile memories having a constant power source (e.g., a battery backup) allowing the volatile memories to operate as long-term storage devices, and/or other pseudo-non-volatile memories (e.g., a dynamic random access memory (DRAM) having a short-term emergency power (e.g., from a battery or super-capacitor) and a non-volatile backing store (e.g., a flash storage capacity equal to the DRAM storage capacity)).

In examples described herein, a system may include a processor with an integrated memory controller, a memory bus, and a memory module having a memory module controller and a memory. The system enables users to store and access data or computer readable instructions in the memory to implement other processes by execution of the instructions. The memory controller of the processor controls memory access operations (e.g., read, write, etc.) performed by the processor via the memory bus. The memory module controller of the memory module controls the memory and may perform memory access operations without processor (or memory controller) intervention.

As described herein, a processor is a general-purpose processing unit able to perform many computing tasks. A memory module controller, by contrast, is not general-purpose but is specialized for controlling memory. Accordingly, as described herein a memory module controller is not a processor. Additionally, as described herein the memory controller is an agent of the processor. Accordingly, when references herein are made to a processor, it is understood that the same references may be referring to the processor and/or the memory controller.

Disclosed examples enable memory modules to perform operations in an autonomous manner by requiring relatively less intervention by external processors or devices (e.g., memory controllers) than required by prior systems. In this manner, disclosed examples enable memory modules to perform memory operations relatively more efficiently by requiring less external communications with processors and/or memory controllers than in prior systems.

Disclosed example memory module controllers may queue or cache memory access requests or commands from processors and/or memory controllers to subsequently perform one or more memory access operations without further intervention by the processors and/or memory controllers. Accordingly, example memory module controllers disclosed herein are capable of autonomously managing and performing memory operations without requiring external control and communications from other processors and/or memory controllers.

Examples disclosed herein substantially decrease the amount of bus communications required from an external processor and/or memory controller when storing or updating data (e.g., via an atomic-write command or a copy-on-write write (COW write) command) in a memory.

Example memory module controllers disclosed herein may be used in memory modules having solid state memory devices. Example memory module controllers disclosed herein perform atomic write and/or COW operations with relatively little involvement from external processors and/or memory controllers (e.g., less commands and data movements over an external memory bus). For example, a disclosed memory module controller may receive a request or command (e.g., an atomic-write or a COW write) from a processor to write or update data at a memory location in a memory module, and execute the request or the command by performing multiple memory accesses (e.g., logging recovery information, writing data to a destination address, and erasing the recovery information) to write and/or update the data at a destination address without requiring further processor intervention beyond the initial request or command received from the processor.

Example memory module controllers disclosed herein may receive atomic commands and in response log associated recovery information in a non-volatile log. When interruptions to corresponding atomic operations occur due to fail-stop events (e.g., system crashes, application crashes, power failures, in some examples events resulting in system reboots), the memory module controller can retrieve the recovery information and either undo or redo the outstanding atomic writes. In some examples, following a fail-stop event (e.g., involving restoration of an operation after an interruption), a processor checks a non-volatile log area of a random access memory, and instructs the memory module controller to undo or redo any outstanding atomic write commands in the log (e.g., that were not previously completed). In some examples, following a reboot, a memory module controller may automatically redo or undo outstanding atomic write commands stored in the log without requiring any processor involvement (e.g., without needing the processor to prompt the memory module controller to perform the not previously completed atomic-write commands). In other examples, the processor checks the log following a fail stop event; if it discovers that one or more atomic writes are outstanding, it uses the recovery information in the log (provided by the memory module controller) to generate the commands needed to either redo or undo each of the outstanding atomic writes. It may then issue one or more commands to erase all the recovery information (e.g., the log contents) or mark all the outstanding atomic writes as completed (e.g., no longer outstanding).

Example methods disclosed herein may involve logging recovery information associated with atomic writes in a log in a memory module. In some examples, a commit record is appended to the log to indicate that execution of an atomic write whose recovery information is stored in the log has been completed. Accordingly, if an interruption occurs (e.g., a system crash, a power failure, etc.), the presence or absence of an associated commit record can be used to determine whether a particular atomic write command whose recovery information has been stored in the log has definitely been fully executed. Disclosed example memory module controllers can then undo and/or redo the commands that are not known to have been fully executed. In some examples, disclosed example memory module controllers undo or redo atomic-write commands based on instructions from a processor. In other examples, disclosed example memory module controllers autonomously undo or redo outstanding atomic-write commands without processor (or memory controller) intervention.

Some disclosed example methods for COW writes involve reading first data from a first address of a memory. In such examples, the first address is specified in a COW write command received by a memory module controller from a processor. Such disclosed example methods also involve updating the first data using modification data located in the same COW write command, and storing the updated data at a second address of the memory. In such examples, the second address is specified in the same write command. In some examples, updating the first data comprises updating the first data by replacing first data at a given offset with new data. In such examples, the offset and new data are specified in the same write command.

Some disclosed example apparatus to execute commands to a memory include at least one memory module (e.g., a random access memory (RAM) module or other type(s) of solid state memory modules). In some examples, the memory module includes a non-volatile memory. In some examples, the memory module includes non-volatile storage areas (e.g., a log).

In some examples, the memory module is a dynamic random access memory (DRAM) with a constant power source (e.g., a battery backup) to persist memory contents through power failures.

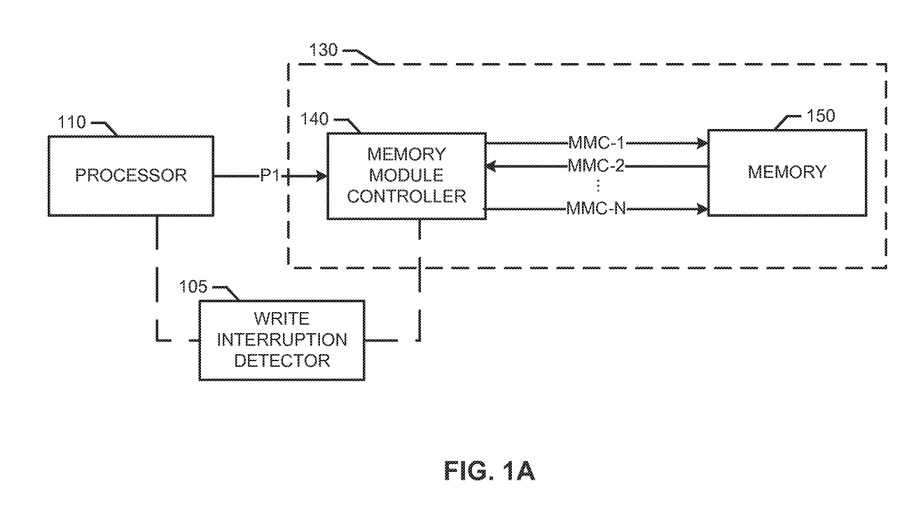

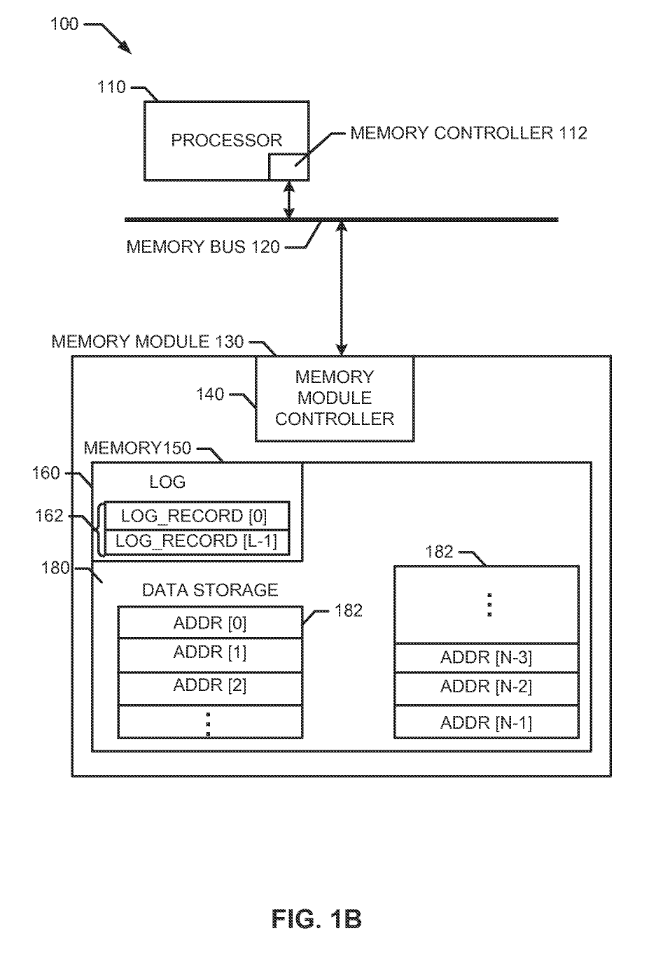

FIG. 1A illustrates an example flow of memory access commands processed by an example memory module controller 140 of a memory module 130 implemented in accordance with the teachings of this disclosure. In the illustrated example, the example memory module controller 140 is in communication with an example write interruption detector 105, an example processor 110, and an example memory 150. Although a single processor 110 is shown in FIG. 1A, one or more processor(s) may be coupled to memory module controller 140 and used in addition to the processor 110.

The example write interruption detector 105 may be located in the processor 110, in the memory module controller 140, or elsewhere. The write interruption detector 105 may determine when execution of a command (e.g., P1) from the processor 110 and/or memory access operation (e.g., MMC-1-MMC-N) has been interrupted (e.g., due to a power failure, a system crash, etc.). Alternatively, the write interruption detector 105 may detect when the system 100 has been restarted after a power failure or system crash.

The example processor 110 sends an example command P1 to the memory module controller 140. The command P1 may be an atomic-write command or a COW write command.

The memory module controller 140 receives the command P1 and accesses the memory 150 using multiple memory access operations (MMC-1 to MMC-N) based on the received command P1. For example, when the memory module controller 140 receives an atomic-write command, the memory module controller 140 may execute multiple commands, such as, log the recovery information associated with the write command (e.g., the destination address and new data of the write command) to a log area (e.g., via MMC-1 command), write the new data to the destination address (e.g., via the MMC-2 command), and indicate (e.g., by writing a commit record) that the command was completed (e.g., via the MMC-N command).

FIG. 1B illustrates an example system 100. The example system 100 includes the example processor 110 of FIG. 1A with an example integrated memory controller 112. In the illustrated example, the processor 110 is in communication with an example memory module 130 via an example memory bus 120. The example memory controller 112 is an interface to facilitate communication between the processor 110 and the memory bus 120. In some examples, the memory controller 112 is not included within the example processor 110, but is instead external to the processor 110 and communicatively coupled with the processor 110 (e.g., via a bus between the processor 110 and the separate memory controller 112). The example memory bus 120 may be implemented using a double data rate (DDR) bus or any other suitable type of memory bus. The example memory module 130 includes the example memory module controller 140 and the example memory 150 of FIG. 1A. In some examples, the memory module controller 140 is implemented using an advanced memory buffer and/or a register in registered memory.

In the illustrated example, the memory 150 in communication with the memory module controller 140 of the illustrated example is a solid state or IC memory device such as a non-volatile RAM device or a volatile DRAM device. In examples that use a volatile DRAM to implement the memory 150, a battery backup is used to enable persistence of data stored in the memory 150 in the event of an interruption in main system power and/or system crash.

The example memory 150 includes an example log 160 and an example data storage area 180. In the illustrated example, the log 160 and the example data storage area 180 are organized separate from one another (e.g., as separate memory areas in a side-by-side organization). In some examples the example log 160 is contained in the example data storage area 180. That is, the log 160 may be accessible to the processor 110 via (special) addresses. The log 160 includes a quantity (L) of log records (e.g., log records 162 LOG_RECORD[0]-LOG_RECORD[L−1]). In the illustrated example, the log 160 is non-volatile (e.g., located in NVRAM). The example log 160 of the memory 150 does not necessarily require a large storage capacity because the log records 162 are typically kept only until completion of corresponding write commands. The data storage area 180 includes a quantity (N) of addressable storage locations 182 (e.g., ADDR[0]-ADDR[N−1]).

Some examples use multiple logs. Each log 160 may be a first-in-first-out (FIFO) data structure (e.g., queue). New log records 162 may be appended to one end of the log 160 and old records may be removed from an opposite end of the log 160. During a recovery, the log records 162 of the log 160 may be processed from one end of the log to the other end, with those log records 162 containing recovery information and without an associated commit record being used to redo or undo writes. In some examples, the log 160 is stored in a buffer 430 of the memory module controller 140 rather than the memory 150. In other examples, recovery information may be stored in data structures other than a log and/or in other locations. In yet other examples, the log 160 may be absent.

In the Illustrated example, the memory module controller 140 is a control center of the memory module 130. The example memory module controller 140 receives commands (e.g., the command P1 of FIG. 1A) from the processor 110 via the memory bus 120. In examples disclosed herein, the memory module 130 may be permanently installed or mounted in the processor system 100 and/or the memory module 130 may be removably mounted or attachable to the processor system 100.

In the illustrated example, the memory module controller 140 controls the memory 150 autonomously based on commands received from the processor 110 and/or any other device (e.g., another processor, etc.) communicatively coupled to the memory bus 120. In this manner, the processor 110 is capable of offloading complex memory processes to the memory module controller 140 as described below.

In the illustrated example, the memory module controller 140 is co-located with the memory 150 in the memory module 130. In some examples, the memory module 130 is implemented using a printed circuit board (PCB), and the memory module controller 140 is mounted with the memory 150 on the PCB. In other examples, the memory module 130 is implemented using a three-dimensional (3D) stack chip package in which an integrated circuit (IC) device implementing the memory module controller 140 and an IC device implementing the memory 150 are stacked on top of one another in a chip with physical intra-chip interconnections between layers of the package. In examples in which the 3D stack chip package implementing the memory module 130 is separate from the processor 110, the 3D stack chip package is provided with an external interface for communication with the processor 110, for example, via the memory bus 120. For examples in which the 3D stack chip package includes the processor 110, the memory module 130 is connected to the processor 110 using intra-chip interconnections. In still other examples, the memory module 130 may be implemented by a multi-drop bus memory module (e.g., a small outline dual inline memory module (SO-DIMM)), a point-to point bus memory module (e.g., a fully buffered DIMM (FBDIMM)), a soldered-on memory, or multi-die packages (e.g., a system on chip (SOC), system in package (SiP), etc.).

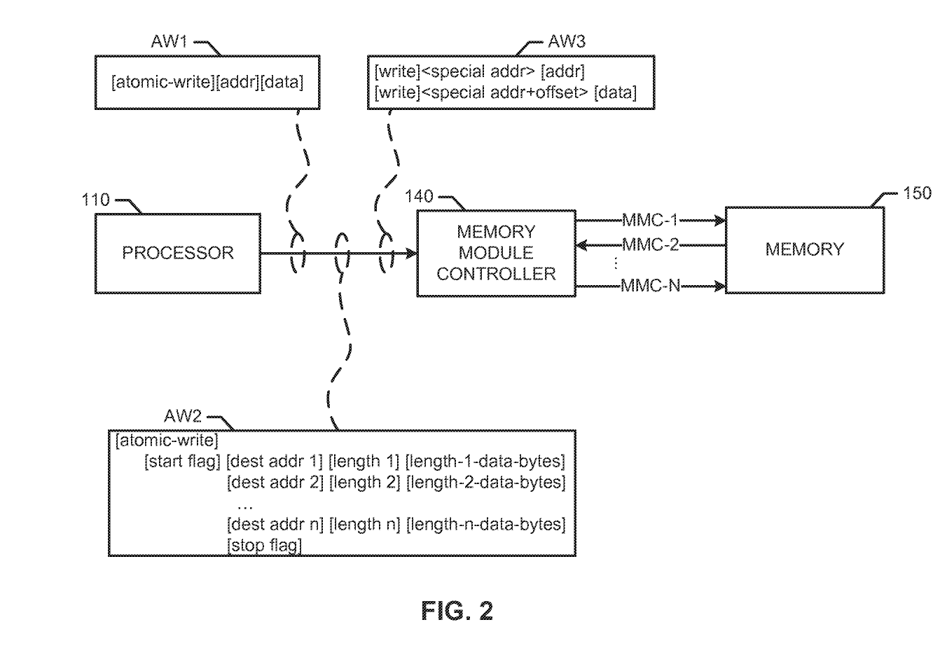

FIG. 2 illustrates example command formats that may be used to cause the example memory module controller 140 of FIGS. 1A and 1B to execute atomic-write commands. In FIG. 2, three different atomic-write (AW) command formats AW1, AW2, AW3 are shown to illustrate different command formats that may be used to cause the memory module controller 140 to perform an atomic-write process. The example processor 110 and the example memory module controller 140 may be configured to use any one or more of the atomic-write command formats AW1, AW2, AW3. If multiple atomic write formats (e.g., one or more of the command formats AW1, AW2, AW3, or any other atomic write command format) are used by the system 100, different command designators may be used to enable the memory module controller 130 to distinguish them. The different parts of the atomic-write command formats AW1, AW2, AW3 are described in detail below in connection with resulting memory access operations (MMC-1 to MMC-N) performed by the memory module controller 140. In some examples, the memory module controller 140 detects that a command (e.g., the command P1 of FIG. 1A) is an atomic write command and thus stores recovery information associated with it in the log 160 based on a detected address or address format in the write command; the memory module controller 140 does not treat write commands as requesting atomicity when those write commands do not include the detected address or address format.

In the illustrated example of FIG. 2, the example atomic-write command format AW1 is represented as:
[atomic-write][addr][data].
   In the illustrated example, [atomic-write] is a command designator (which specifies a type of command), the [addr] parameter specifies a destination address (e.g., a destination addressable memory location) in the memory 150 at which to write data, and the [data] parameter is new data to be written to the destination address. In some examples, the example command format AW1 is similar to a write command format in prior systems except that a different command designator (i.e., [atomic-write]) is used in the example command format AW1. This may allow the processor to mix atomic and non-atomic writes (e.g., the normal write commands). In some examples, all writes are treated atomically.

When the memory controller 140 of the illustrated example receives a command (e.g., the command P1 of FIG. 1A) from the processor 110 in the example command format AW1, the memory module controller 140 of the illustrated example performs memory access operations MMC-1 to MMC-N to perform an update to data at the specified location requested in the received command. For example, the memory module controller 140 may perform the memory access operation MMC-1 to store the recovery information associated with the received atomic-write command, including the destination address [addr](e.g., an address corresponding to an addressable storage location 182), and the new data [data], in a log entry 162 of FIG. 1B. In such examples, the memory module controller 140 may perform the memory access operation MMC-2 to write the new data to the destination address [addr], which corresponds to a storage location 182. The memory module controller 140 may perform the memory access operation MMC-3 to write a commit record as a new log entry 162 at one end of the log 160 indicating that the atomic write operation has completed. That is, MMC-3 appends the commit record to the log 160.

As such, the memory module controller 140 performs the memory access operations MMC-1 to MMC-N without further intervention by the processor 110 over the memory bus 120 beyond receiving an initial atomic-write command (e.g., the command P1 of FIG. 1A).

In the illustrated example, the command format AW2 is represented as follows:

[atomic-write]

[start flag] [dest addr 1] [length 1] [length-1-data-bytes]

[dest addr 2] [length 2] [length-2-data-bytes]
...
[dest addr n] [length n] [length-n-data-bytes]
[stop flag].

The example atomic-write command format AW2 includes sub-writes that cause the memory module controller 140 to update/write data to multiple non-contiguous destination addressable memory locations in an atomic fashion (i.e., either all of the sub-writes happen or none of the sub-writes happen). The command format AW2 thus represents a compound atomic write command. In the illustrated example, the non-contiguous destination addressable memory locations ([dest addr 1], [dest addr 2], to [dest addr n]) may have low or no locality in that they are located across the memory 150 and separated by other non-destination addressable memory locations.

In the example format AW2, the start flag ([start flag]) and the stop flag ([stop flag]) are used to identify the beginning and end of the enclosed sub-writes part (e.g., sub-write 1 is represented by [dest addr 1][length 1][length-1-data-bytes], sub-write 2 is represented by [dest addr 2][length 2][length-2-data-bytes], etc.). The [length-i](where 1≦i≦n) parameters are the byte lengths (or bit lengths) of the data to be updated ([length-i-data-bytes]) at the corresponding destination addressable memory location [dest addr i]. The [length-i-data-bytes] parameters are the data to be written to the destination addressable memory locations. The single command designator [atomic-write] and its accompanying multiple sub-writes of the example command format AW2 are useable to replace multiple single write commands to enable the memory module controller 140 to perform multiple write operations (e.g., the multiple corresponding atomic write operations operations) based on the single compound atomic-write command (e.g., the command P1 of FIG. 1A) having the command format AW2. In the described examples, because the sub-writes of a compound atomic write command (e.g. an atomic write command having the command format AW2) are performed atomically as a group, a single compound atomic write command may not be equivalent to a series of atomic writes, each corresponding to one of the sub-writes.

As an example, when the memory module controller 140 receives a command from the processor 110 in the command format AW2, the memory module controller 140 of the illustrated example performs memory access operations (e.g., at least one of MMC-1 to MMC-N) to perform multiple updates to data at specified addressable memory locations as identified in the received command. In the illustrated example, the memory module controller 140 may perform one or more memory access operations (e.g., at least one of MMC-1 to MMC-N) to store recovery information for each of the sub-writes in the log 160. The memory module controller 140 may store one log record 162 per sub-write or the memory module controller 140 may store a single log record 162 for all of the sub-writes. Accordingly, there may be recovery information associated with each sub-write thus becoming the recovery information for the compound write AW2. The memory module controller 140 may then perform additional memory access operations to write [length-1-data-bytes] to [dest addr 1], to write [length-2-data-bytes] to [dest addr 2], . . . , and then [length-n-data-bytes] to [dest addr n].

As described herein where a multiple byte/word piece of data is described as being read or written from/to a single address, the data is actually read from or written to a series of sequential addresses starting from the given address. This may involve multiple memory access operations to the memory 150 depending on its granularity. For example, reading a 4 byte item from location 100 may involve reading a first byte from location 100, a second byte from location 101, a third byte from location 102, and a fourth byte from location 103.

In some examples, the memory module controller 140 performs additional memory access operations to read back the recovery information to identify the details of the sub-write(s) to be performed next. Finally, the memory module controller 140 may perform a memory access operation to append a single commit record 162 to the log 160 to mark the compound atomic write as having been completed. Thus, the memory access operations MMC-1 to MMC-N are capable of performing multiple write operations from a single compound atomic-write command (e.g., the command P1 of FIG. 1A) received from the processor 110 with command format AW2. As such, the memory module controller 140 performs the memory access operations MMC-1 to MMC-N without further intervention by the processor 110 beyond receiving an initial atomic-write command (e.g., the command P1 of FIG. 1A) in the command format AW2.

In some examples, the start flag [start flag] and/or stop flag [stop flag] of the command format AW2 may be omitted. In such examples, the beginning and/or end of the address and data parameters are implied based on the presence of an atomic-write command designator ([atomic-write]) and/or based on detecting when the processor 110 has stopped transmitting a bus command.

In the illustrated example of FIG. 2, the atomic-write command format AW3 is represented as:
[write]<special addr>[addr]
[write]<special addr+offset>[data].
   In the illustrated example, a new command designator (e.g., [atomic-write]) is not used. Instead, a special address (e.g., <special addr>) is used to indicate that an atomic-write is being requested. In the first line of the command format AW3, the example [write] parameter is a command designator (which specifies a type of command). The <special addr> parameter does not necessarily correspond to any actual physical address, and instead serves as an indicator to inform the memory module controller 140 that the write command is actually an atomic-write command. The [addr] parameter is a base address to be used for calculating destination addresses to which to write subsequently received data (e.g., [data] in the second line of the AW3 format). In the second line of the command format AW3, the [write] parameter is the command designator, the <special addr+offset> indicates an encoded address offset value (offset) for calculating a destination address based on the base address [addr] from the first write command of the AW3 format, and the [data] parameter is the data to be written to the destination addressable memory location of the destination address (e.g., base address [addr]+offset). In the illustrated example, the memory module controller 140 may be configured to atomically write the data [data] to the destination addressable memory location ([addr]+offset) upon receipt of two consecutive write commands having special target addresses (e.g., <special address>+N for N in 0 . . . <limit>). In the illustrated example, when the memory module controller 140 receives a first write command with a special target address parameter (<special addr>), it is configured to wait for a second write command that has a special target address parameter with an encoded offset (<special addr+offset>). The example memory module controller 140 treats the first write command and the second write command as a single atomic-write command (e.g., the command P1 of FIG. 1A). In some examples, a variation of the command format AW3 may be used, in which the memory module controller 140 receives multiple offsets and data in the format [write]<special addr+offset>[data] from the processor 110 to instruct the memory module controller 140 to perform a compound atomic-write with sub-writes (similar to the command format AW2). In such examples, each of the sub-writes includes a different destination addressable memory locations corresponding to a destination address calculated based on the base address [addr] and a subsequent encoded offset value (offset) from a subsequent write command. Furthermore, in such examples, a write command to a special address may be used to indicate to the memory module controller 140 that the compound atomic write is complete.

When the memory module controller 140 of the illustrated example receives a command (e.g., the command P1 of FIG. 1A) from the processor 110 in the command format AW3, the memory module controller 140 of the illustrated example performs memory access operations MMC-1 to MMC-N to perform an update to data at the specified addressable memory location requested in the received command. Memory access operations MMC-1 to MMC-N may be performed in a similar fashion as with the command format AW1 except that [addr] there is [addr]+offset here. As such, the memory module controller 140 performs the memory access operations MMC-1 to MMC-N without further intervention by the processor 110 beyond receiving an initial atomic-write command (e.g., the command P1 of FIG. 1A) in the command format AW3.

In the illustrated example of FIG. 2, in some example uses of the command formats AW2, multiple destination addresses of write commands in a single compound atomic-write command (e.g., the command P1 of FIG. 1A) may have high spatial locality in that they are physically adjacent or near one-another in consecutive addressable memory locations or separate by quantities of addresses that can be represented using offset values. Accordingly, in such examples, rather than supply multiple full destination addresses, the destination address of the first sub-write could be used as a base address for offsets for the remaining sub-writes, thus saving more bandwidth in the case of small scattered write commands exhibiting sufficient spatial locality. Accordingly, the memory module controller 140 may perform one or more memory access operation(s) (MMC-1-MMC-N) to destination addresses determined based on offset values and based on base addresses provided in a command from the processor 110 (e.g., the command P1 of FIG. 1A).

Any appropriate techniques may be used to encode the information of a command. For example, instead of using a start address and a length, a starting and ending address could be used, with the ending address being either inclusive or exclusive. In some examples, a length of data is determined by at least one of a predetermined value, a length field, or difference between a first address and a second address (e.g., the length might be start-end or start-end+1). Additionally, in some examples, a length may be measured in differing units (e.g., bits, bytes, words, etc.).

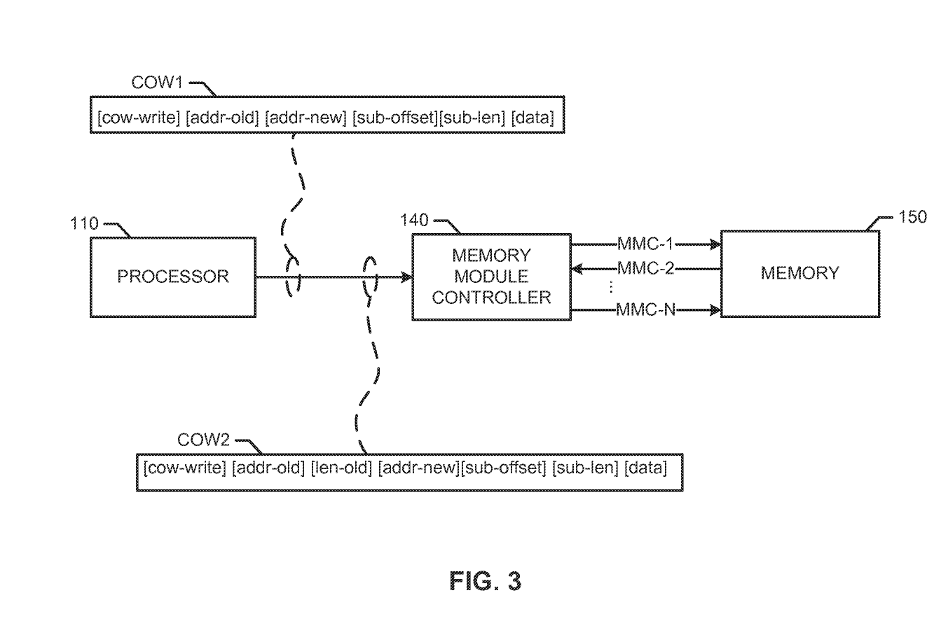

FIG. 3 illustrates example command formats that may be used to cause the example memory module controller 140 of FIGS. 1A and 1B to execute COW-write commands. In FIG. 3, two different COW-write command formats (COW1, COW2) are shown to illustrate different command formats that may be used to cause the memory module controller 140 to perform a COW-write. The example processor 110 and the example memory module controller 140 may be configured to use any one or both of the COW-write command formats COW1, COW2. If both formats COW1, COW2 are used, different command designators may be used to distinguish them. The different parts of the COW-write command formats COW1, COW2 are described in detail below in connection with resulting memory access operations (MMC-1 to MMC-N) performed by the memory module controller 140.

In the illustrated example of FIG. 3, the COW-write command format COW1 is represented as:
[cow-write][addr-old][addr-new][sub-offset][sub-len][data]
   In the illustrated example, [cow-write] is a command designator, the [addr-old] parameter is a first address of an addressable memory location from which old/original data is to be read, the [addr-new] parameter is a destination address of an addressable memory location to which the updated data is to be written, the [sub-len] parameter designates a byte length (or quantity of bytes) of [data], and the [data] parameter is data to be used to update the old/original data. Together, the [sub-offset], the [sub-len], and the [data] comprise modification data. In the command format COW1, the length of the old and new data may be a predefined value, S. In one example, the value S may be the size of a cache line. In another example, S is determined from among a predetermined set of values by the choice of command designator used. In such examples, the command format COW1 is equivalent to copying [addr-old] . . . [addr-old]+S−1 to [addr-new] . . . [addr-new]+S−1, and then writing [data] to [addr-new]+[sub-offset] . . . [addr-new]+[sub-offset]+[sub-len]−1. Accordingly, the copying and writing may be combined so that the old data is read out and the updated data (e.g., the original data updated using the modification data) written directly to the destination address, [addr-new]. This may avoid writing to an address (e.g., [addr-new]+[sub-offset]) twice, first with a portion of the original data and then with a portion of [data].

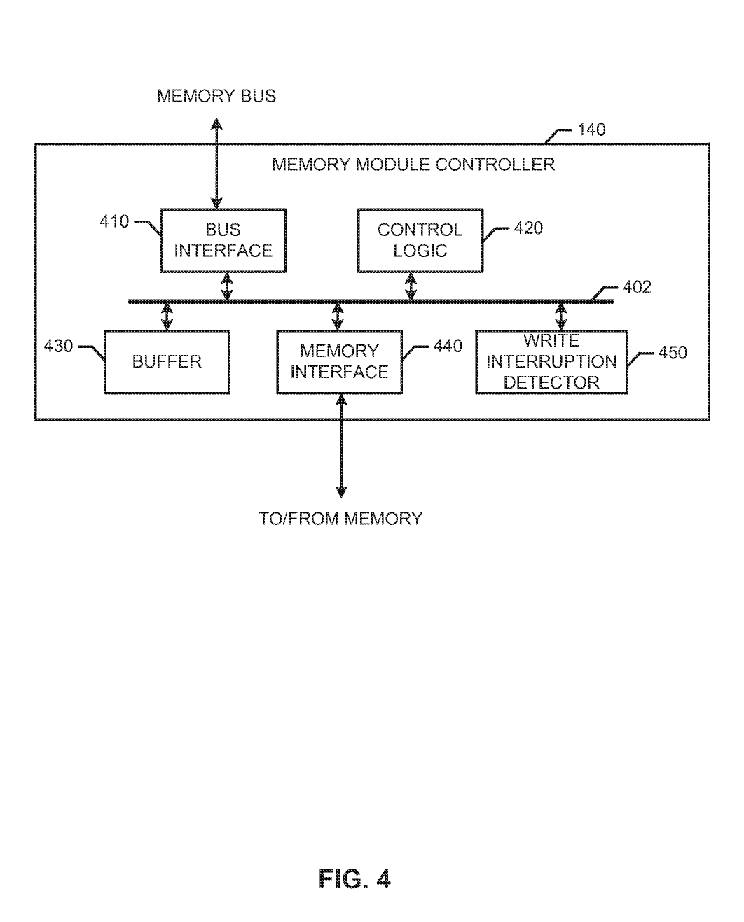

When the memory controller 140 of the illustrated example receives a command (e.g., the command P1 of FIG. 1A) from the processor 110 in the command format COW1, the memory module controller 140 of the illustrated example performs memory access operations MMC-1 to MMC-N to perform a copy-on-write of data at a specified addressable memory location as requested in the received command. For example, the memory module controller 140 performs one or more memory access operations to read S bytes of data (the original data) starting from the addressable memory location located at a first address [addr-old]. In such examples, the memory module controller 140 may perform additional memory access operations to write the updated data to the S destination addressable memory locations starting from the destination address [addr-new]. In such examples, the memory module controller 140 updates the read data by replacing the portion of the read data starting with offset [sub-offset] and of length [sub-len] with [data] before performing the write memory access operations. For example, the memory module controller 140 may perform the update internally using the control logic 420 and the buffer 430 (see FIG. 4). As such, the memory module controller 140 performs the memory access operations MMC-1 to MMC-N without further intervention by the processor 110 beyond receiving an initial COW-write command (e.g., the command P1 of FIG. 1A) in the command format COW1.

In the illustrated example of FIG. 3, the COW-write command format COW2 is represented as:
[cow-write][addr-old][len-old][addr-new][sub-offset][sub-len][data].
   In the illustrated example, [cow-write] is a command designator, the [addr-old] parameter is a first address of an addressable memory location (i.e., a first address that is of an addressable memory location) from which old/original data is to be read, the [len-old] parameter designates a byte length (or quantity of bytes) of data that is to be copied from the first or source addressable memory location, the [addr-new] parameter is a destination address of an addressable memory location to which the updated data is to be written, the [sub-len] parameter designates a byte length (or quantity of bytes) of [data], and the [data] parameter is data to be used to update the old/original data. [sub-offset], [sub-len], and [data] comprise modification data. COW2 is similar to COW1 but allows explicitly specifying the length of the original data/data being updated/updated data rather than using predefined value S.

When the memory controller 140 of the illustrated example receives a command (e.g., the command P1 of FIG. 1A) from the processor 110 in the command format COW2, the memory module controller 140 of the illustrated example performs memory access operations MMC-1 to MMC-N to perform a COW from data at a specified addressable memory location to another specified addressable memory location as requested in the received command. For example, the memory module controller 140 performs one or more memory access operations to read a length [len-old] of old/original data from the source address [addr-old]. In such examples the memory module controller 140 may perform additional memory access operations to write the updated data, which has a length [len-old] to the destination addressable memory location at the destination address [addr-new]. In such examples the memory module controller 140 may update the read data by replacing the portion of the read data starting with offset [sub-offset] and of length [sub-len] with [data] before performing the additional memory access operations. For example, the memory module controller 140 can perform the update using the control logic 420 and the buffer 430. As such, the memory module controller 140 performs the memory access operations MMC-1 to MMC-N without further intervention by the processor 110 beyond receiving an initial COW-write command (e.g., the command P1 of FIG. 1A) in the command format COW2.

Appropriate techniques may be used to implement other example variations of a COW command format in addition to or as an alternative to the command formats COW1, COW2. For example, the length of [data] may be implicit or the modification data may contain multiple tuples of the form [sub-offset], [sub-length], [data] signifying that multiple portions of the original data should be replaced. In other examples, modification data may indicate a portion of the original data to be operated upon by an arithmetic operation such as incrementing or determining it or adding a supplied value to it. The modification data may be used to insert new data at a given point of the original data (e.g., at a first offset of the original data) or to delete a given amount of information at a given point from the original data (e.g., at a second offset of the original data).

In examples disclosed herein, operations of logging and updating in place and copying with modification operations are performed internal to a memory module (e.g., the memory module 130 of FIG. 1B), and not by a processor (e.g., the processor 110 of FIGS. 1A, 1B, 2 and/or 3) or a memory controller (e.g., the memory controller 112 of FIG. 1B). For example, data to be written in an atomic-write (e.g., the atomic-writes of FIG. 2) is sent by the processor 110 across the memory bus 120 to the memory module 130, and the memory module controller 140 stores recovery information associated with the atomic write command to the log area 160 of the memory 150 internally within the memory module 130 without further processor intervention. In other examples, data to be copied (e.g., data copied from a source address [addr_old], updated, then written to a destination address [addr_new]) during a COW-write (e.g., the COW-writes of FIG. 3) is not sent to the processor 110 from the memory module 130 across the memory bus 120, but is instead copied (e.g., read and written) internally within the memory module 130. Accordingly, examples disclosed herein to perform example disclosed atomic-write operations and COW-write operations require relatively less processor intervention and less processor communications across the external memory bus 120 than prior systems, which use significantly more external bus communications to write data.

FIG. 4 is a block diagram of an example implementation of the memory module controller 140 of FIGS. 1A, 1B, 2, and 3. In the illustrated example of FIG. 4, the memory module controller 140 includes an example bus interface 410, example control logic 420 (e.g., a logic circuit), an example buffer 430, an example memory interface 440, and an example write interruption detector 450. An example memory module controller bus 402 facilitates communication between the bus interface 410, the control logic 420, the buffer 430, the memory interface 440, and/or the write interruption detector 450.

While FIG. 4 illustrates an example manner of implementing the memory module controller 140, one or more of the elements, processes, and/or devices illustrated in FIG. 4 may be combined, divided, re-arranged, omitted, eliminated, and/or implemented in any other way. Further, the example bus interface 410, the example control logic 420, the example buffer 430, the example memory interface 440, or the example write interruption detector 450 and/or, more generally, the example memory module controller 140 may be implemented by hardware, software, firmware and/or any combination of hardware, software, and/or firmware. Thus, for example, any of the example bus interface 410, the example control logic 420, the example buffer 430, the example memory interface 440, or the example write interruption detector 450 and/or, more generally, the example memory module controller 140 could be implemented by one or more circuit(s), application specific integrated circuit(s) (ASIC(s)), programmable logic device(s) (PLD(s)) and/or field programmable logic device(s) (FPLD(s)), etc. Further still, the example memory module controller 140 may include one or more elements, processes and/or devices in addition to, or instead of, those illustrated in FIG. 4, and/or may include more than one of any or all of the illustrated elements, processes and devices.

The memory module controller 140 of the illustrated example is provided with the example bus interface 410 to communicatively couple the memory module controller 140 with the external memory bus 120 of FIG. 1B. In the illustrated example, the bus interface 410 manages communications between the memory module controller 140 and the processor 110 and/or any other devices (e.g., other processors) connected thereto via the external memory bus 120.

The memory module controller 140 of the illustrated example is provided with the control logic 420 to manage memory access processes and operations on, for example, the memory 150 of FIGS. 1A, 1B, 2, and 3. The control logic 420 of the illustrated example is configured to perform complex memory access operations as described herein that enable connected processors (e.g., the processor 110) to offload operations of memory access processes to the memory module controller 140. In the illustrated example, the control logic 420 is implemented using a logic circuit. However, software and/or firmware may additionally or alternatively be used to implement the control logic 420.

The memory module controller 140 of the illustrated example is provided with the buffer 430 to temporarily store incoming data and/or commands received via the bus interface 410 and/or to temporarily store outgoing data for communicating to other devices (e.g., processors, external memory controllers, etc.) via the bus interface 410. In some examples, the bus interface 410 is used to temporarily store original data of COW commands.

The memory module controller 140 of the illustrated example is provided with the memory interface 440 to communicatively couple the memory module controller 140 to the memory 150 of FIGS. 1A, 1B, 2, and 3. In the illustrated example, the memory interface 440 includes one or more technology-specific memory controllers (e.g., an NVRAM controller, a DRAM controller, etc.) implemented in accordance with one or more technology-specific industry-standard memory interfaces (e.g., a memory interface standard adopted by the JEDEC Solid State Technology Association such as an NVRAM interface, a DRAM interface, etc.). For example, the memory interface 440 may include a DRAM controller having logic to control pre-charge timing, row-address-strobe (RAS) timings, column-address-strobe (CAS) timings, self-refresh modes, burst access modes, low-power modes, etc.

In the illustrated example, the memory interface 440 is a memory-specific interface intended to facilitate communications with one or more specific types of memories onboard the memory module 130, while the bus interface 410 may be but is not necessarily specific to any particular type of memory technology.

The memory interface 440 of the illustrated example may be configurable to be used in memory modules having only a volatile DRAM, or in memory modules having only non-volatile RAM. In some examples, the memory interface 440 enables implementing a hybrid memory module having different types of memory such as different types of volatile memory (e.g., DRAM and SRAM) on a single memory module, different types of non-volatile memory (e.g., PCRAM and Memristors) on a single memory module, and/or different types of volatile and non-volatile memory (e.g., DRAM and PCRAM, DRAM and Memristors, etc.) on a single memory module. In some such examples, to implement such hybrid memory modules, the memory interface 440 may include multiple types of technology-specific memory controllers (e.g., DRAM controllers, PCRAM controllers, Memristor controllers, SRAM controllers, etc.) so that the memory module controller 140 can communicate with different types of memory technologies on the same memory module.

The example write interruption detector 450 of FIG. 4 may be used to implement the write interruption detector 105 of FIG. 1A. Although the write interruption detector 450 is shown within the memory module controller 140 it may additionally or alternatively be provided in the processor 110 of FIGS. 1A, 1B, 2, and 3 or external from the memory module controller 140 and the processor 110 and communicatively coupled to the memory bus 120 of FIG. 1B, or within any other device (e.g., another processor) in communication with the memory module controller 140.

The write interruption detector 450 of the illustrated example determines whether a command (e.g., a write command, an atomic-write command, a COW-write command, etc.) may have been interrupted. Alternatively, the write interruption detector 450 may determine whether the system 100 has just been restarted. In some examples, the memory module controller 140 uses the write interruption detector 450 to determine whether a recovery operation is to be performed (e.g., following a fail-stop event).

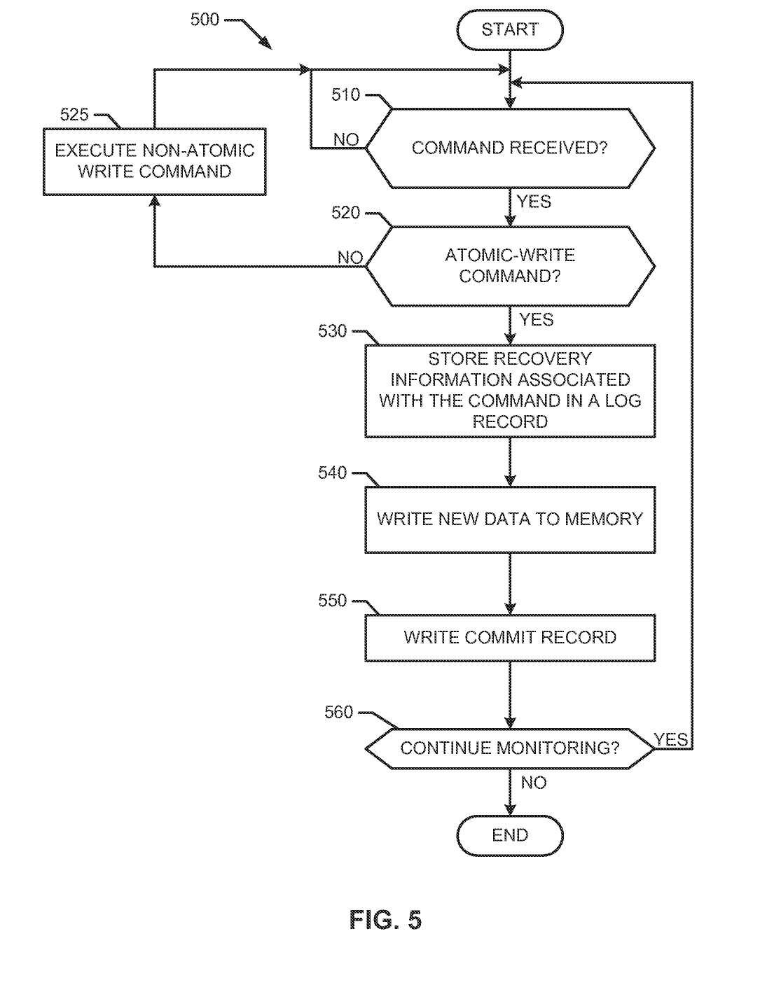

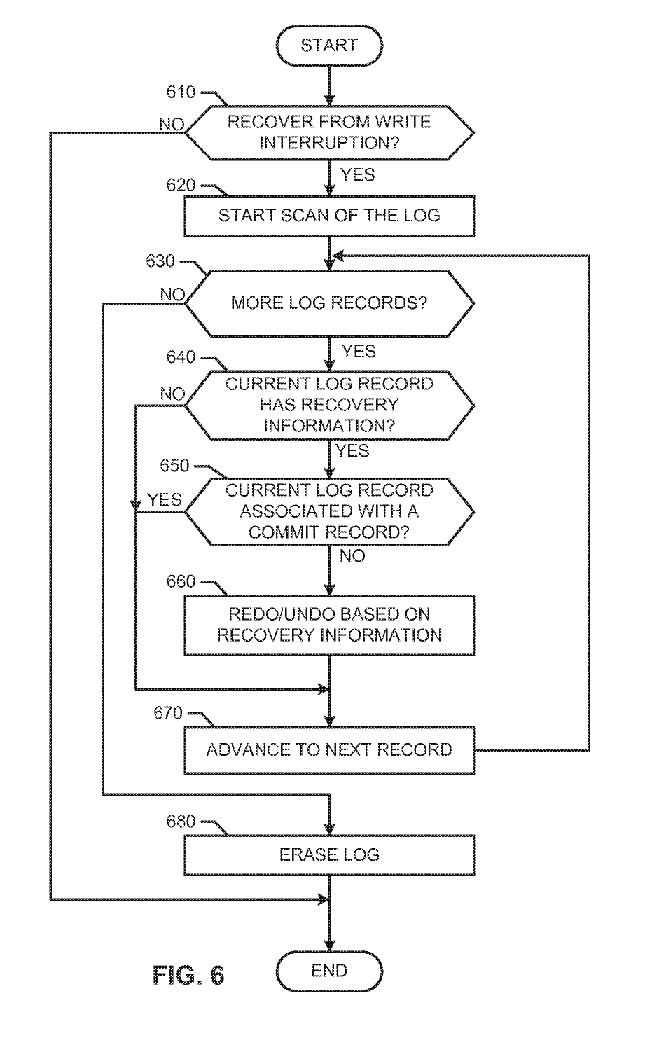

Flowcharts representative of example processes for implementing the memory module controller 140 of FIGS. 1A, 1B, 2, 3, and 4, are shown in FIGS. 5, 6, and/or 7. In these examples, the processes may be performed by the control logic 420 of FIG. 4. In some examples, a logic circuit as described above may implement the control logic 420 to perform the example processes. In some examples, a program or portions thereof to configure the control logic 420 may be stored on a tangible computer readable storage medium such as a solid state read only memory (ROM) device, an integrated circuit (IC) memory device, embedded hardware memory, a logic circuit, a flash memory, a cache, a random access memory (RAM), or a memory associated with the control logic 420 and/or embodied in firmware or dedicated hardware. Further, although the example processes are disclosed with reference to the flowcharts illustrated in FIGS. 5, 6, and/or 7, many other methods of implementing the memory module controller 140 may alternatively be used. For example, the order of execution of the blocks may be changed, and/or some of the blocks described may be changed, eliminated, or combined.

As mentioned above, the example processes of FIGS. 5, 6, and/or 7 may be implemented by the control logic 420. The control logic 420 may be configured using a program stored in a tangible computer readable medium such as a solid state read only memory (ROM) device, an integrated circuit (IC) memory device, embedded hardware memory, a logic circuit, a flash memory, a cache, a random access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the control logic 420 may be configured using a program stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

An example process 500 that the memory module controller 140 of FIGS. 1A, 1B, 2, and 4 may use to perform atomic-write commands received from the processor 110 (e.g., FIGS. 1A, 1B, 2) is represented by the example flowchart shown in FIG. 5. The process 500, is iterative. The memory module controller 140 may process multiple commands using the process 500 in parallel to one another.

In the illustrated example process 500, the memory module controller 140 receives commands (e.g., a read followed by an atomic-write such as the command P1 of FIG. 1A) from the processor 110 to perform memory access operations. In the illustrated example, upon receiving an atomic write command and when not interrupted, the memory module controller 140 stores recovery information and then performs the write based on that single atomic-write command without requiring further commands from the processor 110 via the external memory bus 120.

Initially, at block 510 of the illustrated example of FIG. 5, the control logic 420 (FIG. 4) determines whether a new command has been received from the processor 110 yet (FIGS. 1A and 1B) via the bus interface 410 (FIG. 4). In some examples, the control logic 420 determines whether a command is waiting in a queue of the buffer 430 (FIG. 4). If a command has been received (block 510), control advances to block 520. If a command has not been received (block 510), the control logic 420 continues to monitor the bus interface 410 and/or the buffer 430 to determine if a command has been received from the processor 110.

At block 520 of the illustrated example, the control logic 420 determines whether the received command is an atomic-write command. For example, the control logic 420 may determine the type of command based on a command designator (e.g., using the atomic-write command formats AW1 and AW2) and/or a special address (e.g., using the atomic-write command format AW3) specified in the received command as described above in connection with FIG. 2. If the received command is not an atomic-write command (block 520), control advances to block 525, where the control logic 420 and/or the memory interface 440 executes the received command (e.g., according to its command designator). For example, the control logic 420 and/or the memory interface 440 may execute a read command, a non-atomic write command, a low-power transition command, etc. If the control logic 420 determines that the received command is an atomic-write command (block 520), control advances to block 530.

At block 530, the control logic 420 causes the memory interface 440 to store recovery information associated with the command in one or more log records 162 (FIG. 1B) of the memory 150 (FIGS. 1A, 1B, 2). Recovery information may comprise the destination address(es), the new data, and/or the previous contents of the destination address(es). The recovery information is used to facilitate redoing or undoing a write requested by the write command in the event that the write is interrupted.

At block 540, the memory interface 440 writes the new data of the atomic-write command to the destination location(s) 182 of the memory 150 corresponding to the destination address(es) of the atomic-write command. In the example of FIG. 5, at block 540 the data is written without processor (or memory controller) intervention (e.g., an additional write request beyond the original atomic write command, instruction message, etc.) from the processor 110. After block 540, control advances to block 550.

At block 550 of the illustrated example, the memory interface 440 writes a commit record to indicate that the atomic-write command has been completed. In some examples, at block 550, the memory module controller 140 may remove log records 162 from the log 160 that are no longer needed because those log records 162 are no longer associated with outstanding atomic writes. Thus, the recovery information associated with an atomic write may be eventually erased. In some examples, a lock may be used to ensure that appending to the log 160 is an atomic operation. In some examples, commit records are not used and some other method of marking outstanding atomic-writes as no longer being outstanding is used.

After block 550, the control logic 420 determines whether to continue monitoring the bus interface 410 and/or the buffer 430 (block 570) for further commands from the processor 110. If the control logic 420 determines that it should no longer monitor receipt of commands (e.g., the system is entering a shutdown or a sleep mode, the memory module 130 has been communicatively disconnected from the processor 110, etc.) the example process 500 ends. However, if the control logic 420 determines that it should continue monitoring receipt of commands, control returns to block 510, where the control logic 420 awaits a next command from the processor 110 or other device via the external memory bus 120.

The above atomic-write process of FIG. 5 may be used to ensure atomicity of atomic write commands. Accordingly, when an atomic-write process is interrupted (e.g., the processor 110 is rebooted due to a power failure, system crash, etc.), a recovery may be performed using, for example, the process 600 of FIG. 6. In some examples if the process 500 is interrupted, some of the processing of an atomic-write command may not be completed by the process 500. For example, a write of the new data to memory to be done by block 540 may not have been accomplished by the process 500 if the write is interrupted.

In FIG. 6, the process 600 may be executed by the memory module controller 140 of FIGS. 1A, 1B, 2, and 4 to perform a recovery from a write interruption (e.g., due to a crash, loss of power, etc.). At block 610, the control logic 420 (FIG. 4) determines whether to perform recovery. In some examples, the memory module controller 140 determines whether to perform the interrupted-write recovery process based on an indication from the write interruption detector 450. For example, the write interruption detector 450 may determine whether a system crash and/or power failure occurred (e.g., based on a system crash flag, a power failure flag, a reboot flag, etc.).

In some examples, the memory module controller 140 determines whether to perform a recovery process based on information (e.g., a status message, a recovery command, etc.) received from the processor 110, based on the status of the memory 150 (e.g., the log area 160 includes incomplete commands), based on hardware recovery operations being performed (e.g., a disk rebuild), etc. For example, a system crash or a power failure may interrupt an initial attempt to perform a memory access operation of an atomic write command.

In the illustrated example of FIG. 6, the memory module controller 140 performs an interrupted-write recovery process to recover data by redoing or undoing any outstanding atomic-write(s). In some examples, the process 600 of FIG. 6 may be initiated by the processor 110 or other device sending commands to the memory module controller 140 via the external memory bus 120 to perform a recovery process. Initially, in the illustrated example of FIG. 6, if the memory module controller 140 is not to perform an interrupted-write recovery (block 610), the control logic 420 ends the interrupted-write recovery process 600. If the memory module controller 140 is to perform an interrupted-write recovery, control advances to block 620.

At block 620 of the illustrated example, the control logic 420 (FIG. 4) begins scanning the log 160. In some examples, at block 620, the control logic 420 sets a pointer to point to the earliest or latest log record 162 of the log 160. In some examples where writes are to be redone, the log 160 may be scanned from an oldest to a most recent log record 162. In examples where writes are to be undone, the log 160 may be scanned from the most recent to the oldest log record 162.

At block 630 of FIG. 6, the control logic 420 checks the log 160 to determine if any more log records 162 of the log 160 remain to be processed. If no log records 162 remain to be processed, control proceeds to block 680. If log records 162 do remain to be processed, control proceeds to block 640.

At block 640 of FIG. 6, the control logic 420 checks a current log record 162 of the scan to determine if the current log record 162 has recovery information. If the current log record 162 does not have recovery information, control proceeds to block 670. If the current log record 162 does include recovery information, control proceeds to block 650.

At block 650 of FIG. 6, the control logic 420 checks if the current log record 162 is associated with a commit record. If the current log record 162 is associated with a commit record, then the current log record 162 is associated with an atomic-write that is no longer outstanding (e.g., it has been completed) and control proceeds to block 670. If the current log record 162 is not associated with a commit record then control proceeds to block 660. In some examples, log records 162 may be associated with commit records by each log record 162 (including commit records) including a number of the command (e.g., a count of commands received so far) with which that log record 162 is associated; a log record 162 is considered associated with a commit record if the log record 162 and the commit record have the same command number.

At block 660, the control logic 420 may perform a redo of an interrupted write (or sub-write) corresponding to the recovery information in the current log record 162 (e.g., the control logic writes new data included in the recovery information to the destination address included in the recovery information). Alternatively, control logic 420 may perform an undo of the interrupted write (or sub-write) corresponding to the recovery information in the current log record 162 (e.g., the control logic 420 writes old data included in the recovery information to the destination address included in the recovery information). In some examples, either redo is always used or undo is always used.

At block 670 of FIG. 6, the control logic 420 advances to the next log record 162 in the log 160. This may involve advancing a pointer to the current log record 162 in the direction the log 160 is being scanned. Control then returns to block 630 to determine whether more log records 162 remain to be processed. If no log records 162 remain to be processed control advances to block 680.

If no log records remain to be processed (at block 630) all outstanding atomic-writes that may have been interrupted have been redone or undone. Accordingly, at block 680, the control logic 420 may erase the entire log 160 in an atomic fashion. Such a process erases all the recovery information and indicates that there are no outstanding atomic writes anymore. In some examples, control logic 420 writes a commit record to the log 160 after it finishes processing all the log records 162 associated with a given atomic write (or compound atomic write) command for the corresponding write command. Such a process may save resources if the recovery itself is interrupted.

In some examples, following an interruption of an atomic-write (e.g., while recovery information associated with P1 of FIG. 1A is logged in the log 160 (FIG. 1B) of the memory 150 and/or being received by the memory module controller 140), firmware, software, and/or hardware running on the processor 110 may be configured to check the log 160 of the memory 150. In some examples the processor 110 may send multiple commands to the memory module controller 140 to perform memory access operations to initiate an interrupted-write recovery process (e.g., the example process 600). In some examples, recovery tools (e.g., recovery software, firmware, etc.) in the hardware (e.g., the solid state device, hard disk drive, etc.) of the memory 150, and/or hardware device associated with the memory 150, independently performs a recovery process (e.g., the example process 600) from a write-interruption automatically on resumption of power to the memory 150 or when commanded by the processor 110.

In a different example, the process 600 is not performed by the memory module controller 140 relatively autonomously. Instead, the process 600 is performed by the processor 110 using recovery information provided to the processor 110 for use in undoing or redoing writes. That is, the processor 110 reads the log 160 with help from the memory module controller 140 using memory commands; following a similar process as the process 600, the processor 110 issues the appropriate non-atomic write commands to the memory 150 to redo or undo each outstanding atomic write. The processor 110 may then erase the log 160 using another command. In examples where the processor 110 is to perform recovery, the memory module controller 140 may be configured to perform fewer tasks than if the memory module controller 140 is to perform the recovery.

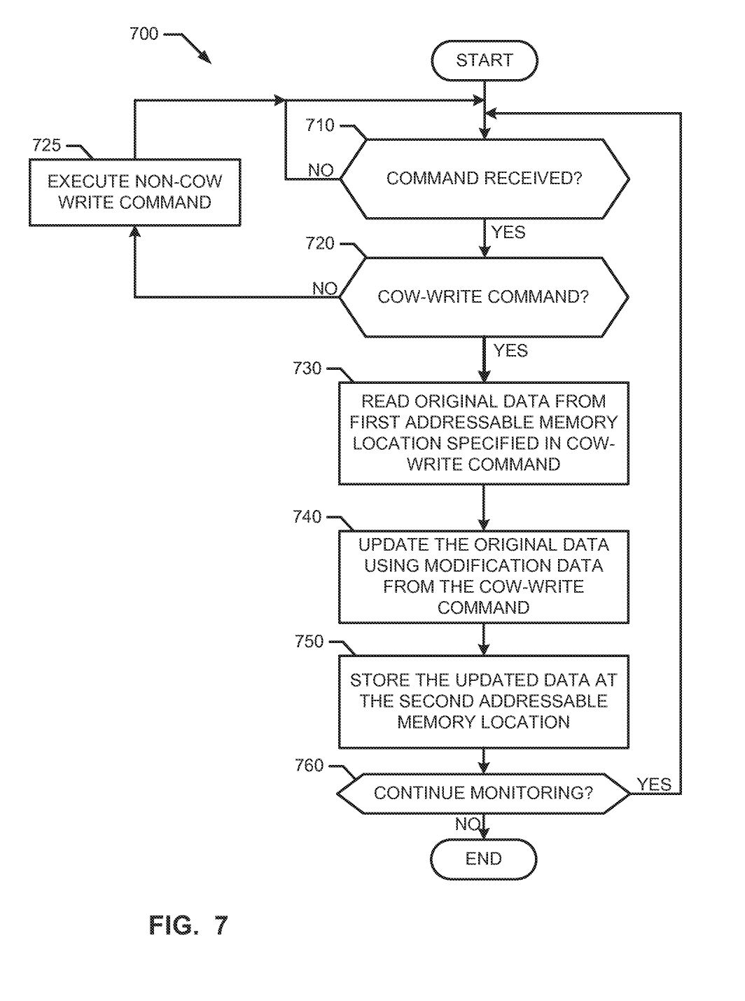

An example process 700 that may be executed by the memory module controller 140 of FIG. 1A, 1B, 3, or 4 to perform a COW-write command received from the processor 110 (FIGS. 1A, 1B, 3) is represented by the flowchart shown in FIG. 7. In the illustrated example process 700, the processor 110 transmits a single command (e.g., a COW-write) to the memory module controller 140 to perform a multi-memory access operation. The example memory module controller 140 performs the multi-memory access operation based on the single COW-write command from the processor 110 without requiring further commands from the processor 110 via the external memory bus 120.

Initially, at block 710 of the illustrated example of FIG. 7, the control logic 420 (FIG. 4) determines whether a command has been received from the processor 110 (FIGS. 1A, 1B, and 3) via the bus interface 410 (FIG. 4). In some examples, the control logic 420 determines whether a command is waiting in a queue of the buffer 430 (FIG. 4). If a command has been received (block 710), control advances to block 720. If a command has not been received (block 710), control continues to monitor the bus interface 410 and/or the buffer 430 at block 710 to determine if a command has been received from the processor 110.

At block 720 of the illustrated example, the control logic 420 determines whether the received command is a COW-write command. For example, the control logic 420 may determine the type of command received based on a command designator (e.g., [cow-write] designator in the COW command formats COW1 and COW2 of FIG. 3) in the command message as described above in connection with FIG. 3. If the received command is a non-COW-write command (block 720), control advances to block 725, where the control logic 420 and/or the memory interface 440 executes the received command (e.g., according to a command designator of the received command). For example, the control logic 420 and/or the memory interface 440 may execute a read command, a normal write command, or an atomic-write command, a low-power transition command, etc. If the control logic 420 determines that the received command is a COW-write command (block 720), control advances to block 730.

In blocks 730, 740, and 750 of FIG. 7, the control logic 420 uses the memory interface 440 to execute the COW-write command without further intervention by the processor 110. For example, at block 730, the memory interface 440 reads original data from a first addressable location 182. The first addressable location 182 (e.g., ADDR[1] of FIG. 1B) is specified in an old (or source) address parameter (e.g., the [addr-old] parameter of the COW1 and COW2 formats of FIG. 3). The original data may be held in buffer 430 or copied to a second addressable location 182 (e.g., ADDR[3] of FIG. 1B) specified in a new or destination address parameter (e.g., the [addr-new] parameter of the COW1 and COW2 formats of FIG. 3).

At block 740, the memory interface 440 updates the original data using modification data to create updated data. This updating may be performed on original data held in buffer 430 or on a copy of the original data at the second addressable location 182. The updating may be done by replacing a portion of the original data starting at a first offset with new data.

At block 750 of the illustrated example, the memory interface 440 stores the updated data at the second addressable location of the memory 150 according to the COW-write command. This may involve copying the updated data from the memory buffer 430. In some examples, blocks 740 and 750 are performed simultaneously by first copying the original data to the second addressable location of the memory 150 and modifying it in place. In other examples, blocks 740 and 750 are performed simultaneously or substantially simultaneously by modifying the original data while copying it from the first addressable location of the memory 150 to the second addressable location of the memory 150. For example, the memory interface 440 may copy the original data from the first addressable location that is not covered by a first offset (e.g., portion(s) of the original data that is/are not to be changed) to the second addressable location, and write the new data to the second addressable location plus the first offset. Other appropriate techniques of reading the original data, modifying it, and/or storing it may be implemented.

In some examples, where original data has a substantial length, blocks 730, 740, and 750 may be repeated several times. For example, a first portion of the original data may be read, updated, and stored, followed by a second portion of the original data being read, updated, and stored. In some examples, these blocks are performed in parallel.

After block 750, the control logic 420 determines whether to continue monitoring the bus interface 410 and/or the buffer 430 for received commands (block 760). If the control logic 420 determines that the memory module 140 is no longer to monitor receipt of commands (e.g., the system is entering a shutdown, the memory module 130 has been communicatively disconnected from the processor 110, etc.) the example process 700 ends. However, if the control logic 420 determines that the memory module is to continue monitoring receipt of commands (block 760), control returns to block 710, where the control logic 420 awaits a next command from the processor 110 or other device via the external memory bus 120.

Although the examples processes of FIGS. 5-7 are shown and described independent of one another, in some examples any one or more of the example processes of FIGS. 5-7 may be performed together in parallel or in seriatim on the same system using the same and/or different memory modules or memory nodes. For example, FIG. 5 and FIG. 7 may be both be implemented by a single memory module controller 140 such that FIG. 5 is implemented to execute atomic write commands and FIG. 7 is implemented to execute COW write commands.

The example methods and apparatus described herein enable more efficient use of an external memory bus of a system and ensure consistent updates of memory through the use of a non-volatile log in a random access memory and/or COW.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A method comprising:
storing recovery information associated with a write request in a memory without processor intervention, the recovery information to facilitate redoing or undoing a write requested by the write request in the event that the write is interrupted, the write request received from a processor and comprising a destination address and new data; and
if the write is not interrupted, writing the new data to the destination address in the memory without processor intervention.

2. A method according to claim 1, wherein storing the recovery information without processor intervention comprises storing the recovery information in a non-volatile log of the memory without processor intervention.

3. A method according to claim 1, further comprising:
after a system crash or a power failure that interrupts the write, performing at least one of redoing the write or undoing the write based on the recovery information without processor intervention.

4. A method according to claim 2, further comprising:
if the write is interrupted, using the recovery information to write the new data to the destination address in the memory without processor intervention.

5. A method according to claim 1, further comprising:
after an interruption of the write, providing the recovery information to the processor for use in undoing or redoing the write.

6. An apparatus comprising:
a bus interface to receive a write request from a processor to write to a memory comprising a destination address and new data; and
a logic circuit to cause storing of recovery information associated with the write request, the recovery information to facilitate redoing or undoing a write associated with the write request in the event that the write is interrupted.

7. An apparatus according to claim 6, wherein, if the write is not interrupted, the logic circuit is further configured to:
write the new data to the destination address in the memory, and
erase the recovery information without processor intervention after the new data is written to the destination address.

8. An apparatus according to claim 6, wherein the logic circuit is further configured to:
store the destination address and new data as the recovery information; and
after an interruption of an attempt to perform a memory access operation of the write request, write the new data to the destination address in the memory.

9. An apparatus according to claim 6, wherein the logic circuit is further configured to:
read the contents in the memory of the destination address;
store the destination address and the read contents as the recovery information; and
after an interruption of the write, write the read contents to the destination address in the memory.

10. An apparatus according to claim 6, wherein the logic circuit and the bus interface are collocated in a memory module of the memory.

11. An apparatus according to claim 6, wherein the recovery information is stored in a log in the memory.

12. A tangible computer readable storage medium comprising instructions that, when executed, cause a machine to at least:
issue a write request comprising a destination address and new data to a memory module,
wherein, in response to receiving the write request, the memory module stores recovery information associated with the write request to facilitate undoing the write or redoing the write in the event of an interruption of the write.

13. An apparatus comprising:
a bus interface to receive a copy-on-write write command from a processor, the copy-on-write write command comprising a first address, a second address, and modification data; and
a logic circuit to read first data from the first address in a memory, update the first data using the modification data, and store the updated data at the second address in the memory.

14. An apparatus according to claim 13, wherein the modification data comprises an offset and new data, and the logic circuit is further to update the first data using the modification data by replacing first data at the offset with the new data.

15. An apparatus according to claim 13, wherein the logic circuit is further to update the first data using the modification data by at least one of inserting new data at a first offset in the first data or deleting data at a second offset in the first data.

16. An apparatus according to claim 13, wherein a length of the first data is determined by at least one of a predetermined value, a length field of the copy-on-write write command, or a difference between the first address and a third address of the copy-on-write write command.

17. An apparatus according to claim 13, wherein the logic circuit and the bus interface are collocated in a memory module of the memory.

18. A method comprising:
reading first data from a first address in a memory without processor intervention, the first address specified in a copy-on-write write command received from a processor;
updating the first data using modification data of the copy-on-write write command without processor intervention; and
storing the updated data at a second address of the copy-on-write write command in the memory without processor intervention.

19. A method according to claim 18, wherein the modification data comprises an offset and new data, and the method further comprising updating the first data using the modification data by replacing first data at the offset with the new data.

20. A method according to claim 18, further comprising updating the first data using the modification data by least one of inserting new data at a first offset of the first data or deleting old data at a second offset of the first data.

21. A method according to claim 18, wherein a length of the first data is determined by at least one of a predetermined value, a length field of the copy-on-write write command, or a difference between the first address and a third address of the copy-on-write write command.

22. A tangible computer readable storage medium comprising instructions that, when executed, cause a machine to at least:
send a copy-on-write write request to a memory module, the copy-on-write write request comprising a first address, a second address, and modification data,
wherein, in response to receiving the write request, the memory module reads first data from the first address in a memory, updates the first data using the modification data, and stores the updated data at the second address in the memory.
